(19) United States
(12) Patent Application Publication
(10) Pub. No.: US 2010/0223396 A1
(43) Pub. Date: Sep. 2, 2010

(54) INTELLIGENT STATUS POLLING

(75) Inventors: Yogesh Bhootada, Milpitas, CA (US); Randy Ho, Sunnyvale, CA (US); Kishore Nair, Fremont, CA (US); Brian Lam, San Jose, CA (US); Durgadatt R. Kamath, Cupertino, CA (US)

Correspondence Address: FIALA & WEAVER, P.L.L.C.;C/O CPA GLOBAL, P.O. BOX 52050, MINNEAPOLIS, MN, 55402, US

(73) Assignee: YAHOO! INC., Sunnyvale, CA (US)

(21) Appl. No.: 12/395,492

(22) Filed: Feb. 27, 2009

(51) Int. Cl. G06F 15/173

(52) U.S. Cl. 709/234

(57) ABSTRACT

Systems, methods, and computer program products are described that intelligently determines the status of a process. The process is performed with respect to a creative asset that may be included in an online ad, for example. The status of the process is requested at a poll time that is calculated based on at least one attribute of the creative asset. For example, the calculated poll time may be based on a duration of a video associated with the creative asset, a weight (i.e., bitsize) of the creative asset, etc.

### BACKGROUND OF THE INVENTION

1. Field of the Invention

The present invention generally relates to techniques for determining the status of a process.

2. Background

Certain online advertisement (“ad”) networks enable online ads to be served to users visiting the Web sites of publishers that are participating in the online ad network. Advertisers generate the online ads and buy placements (a.k.a. inventory) for those ads on the publishers' Web sites usually based on the anticipated audiences for those sites. A placement represents a publisher's agreement to serve a trafficked (i.e., specified) ad to users when the users visit the publisher's site. The publisher often serves the trafficked ad contemporaneously with other content associated with the publisher's site.

Each time a user visits a Web site, an impression is said to occur. The impression causes an ad call (also referred to as an impression call) to be generated. The ad call initiates retrieval of the trafficked ad, which the publisher serves to the user in fulfillment of the purchased placement.

Advertisers may upload creative assets to an asset processing system within an online ad network for inclusion in online ads that are served to users. A creative asset is well known in the relevant art(s) to be a media component of an online ad. For example, the creative asset may be an audio component, an image component, and/or a video component of an online ad. Some types of creative assets are processed before being included in the online ads. Video files, for example, are often encoded into a designated format, so that they can be played on the Web pages on which they are served.

Because the encoding process may be resource-intensive, it may be deemed desirable for the asset processing system to send such video files to a remote server for asynchronous encoding. However, in such a scenario, some technique must be implemented by which the asset processing system may determine the status of the video encoding process. The technique should be efficient and avoid consuming substantial bandwidth and/or resources of the online ad networks.

Thus, systems, methods, and computer program products are needed that are capable of intelligently determining the status of a process, such as an asynchronously-executed video encoding process, in an efficient manner.

### BRIEF SUMMARY OF THE INVENTION

Systems, methods, and computer program products are described herein for intelligently determining the status of a process. The process is performed with respect to a creative asset, such as a video file, an audio file, an image file, etc. Embodiments of the present invention request the status of the process at a poll time that is calculated based on at least one attribute associated with the creative asset. Example attributes include but are not limited to a weight (i.e., bit size) of the creative asset, dimensions (i.e., number of pixels in the x and y directions) of a video associated with the creative asset, a duration of the video or audio associated with the creative asset, etc.

By polling the process based on a calculated poll time, an embodiment of the present invention can advantageously increase the efficiency of a polling operation, as compared to conventional polling techniques. The intelligent status polling techniques described herein may consume less bandwidth and/or fewer resources of a system, as compared to conventional polling techniques.

In particular, a method is described in which an indicator is received. The indicator indicates that a processing system is starting to perform a process on a video file at a start time. A poll time is calculated based on the start time and a wait time. The wait time is based on at least one attribute associated with the video file. A status of the process is requested at the poll time.

A computer program product is also described herein. The computer program product includes a computer-readable medium having computer program logic recorded thereon for enabling a processor-based system to poll a process performed with respect to a video file. The computer program logic includes a first program logic module and a second program logic module. The first program logic module is for enabling the processor-based system to calculate a poll time based on a start time and a wait time in response to receiving an indicator indicating that the process is starting at the start time. The wait time is based on at least one attribute associated with the video file. The second program logic module is for enabling the processor-based system to poll the process at the poll time.

A system is also described herein. The system includes a processing module, a poll time calculation module, and a status request module. The processing module is configured to perform a process on a video file. The poll time calculation module is configured to calculate a poll time based on at least one attribute associated with the video file. The status request module is configured to request a status of the process at the poll time

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of an example online advertisement (“ad”) network in accordance with an embodiment of the present invention.

FIG. 2 is a block diagram of an example implementation of the creative asset processing system shown in FIG. 1 in accordance with an embodiment of the present invention.

FIG. 3 depicts an activity diagram of a send queue job in accordance with an embodiment of the present invention.

FIG. 4 depicts an activity diagram of a poll queue job in accordance with an embodiment of the present invention.

FIG. 5 depicts an activity diagram of a receive queue job in accordance with an embodiment of the present invention.

FIG. 6 depicts a flowchart of a method for polling a process based on a calculated poll time in accordance with an embodiment of the present invention.

FIG. 7 is a block diagram of another example implementation of the creative asset processing system shown in FIG. 1 in accordance with an embodiment of the present invention.

FIG. 8 is a block diagram of a computer system that may be used to implement one or more aspects of the present invention.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention. For instance, although the embodiments described herein refer specifically, and by way of example, to online advertisement (“ad”) networks, it will be readily apparent to persons skilled in the relevant art(s) that embodiments are equally applicable to other types of networks and/or systems.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

II. Example Online Advertising Network

Embodiments of the present invention intelligently determine the status of a process, such as an asynchronously-executed video encoding process, in an efficient manner. The status of the process is requested at a poll time that is based on at least one attribute associated with a creative asset that is the subject of the process. The creative asset may be a video file, an audio file, an image file, etc. Example attributes include but are not limited to a weight (i.e., bit size) of the creative asset, dimensions (e.g., width and height) of video associated with the creative asset, video duration, video aspect ratio (e.g., width versus height), video frame rate, video key frame interval, video sampling rate, video codec, audio sampling rate, audio codec, audio mono/stereo, etc.

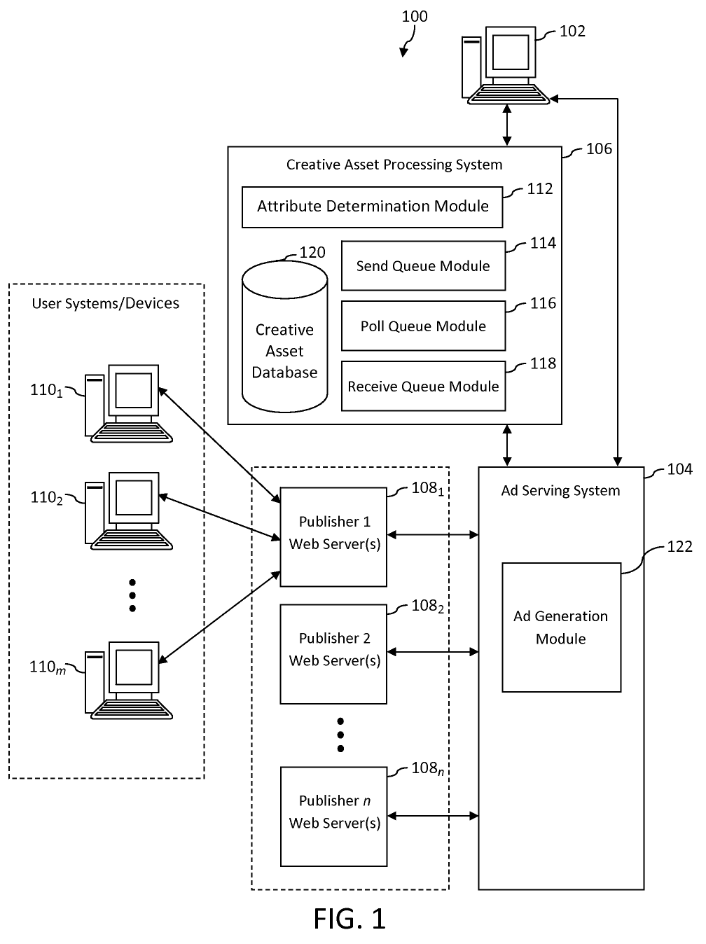

FIG. 1 is a block diagram of an example online ad network in accordance with an embodiment of the present invention. Generally speaking, online ad network 100 operates to serve online ads provided by advertisers to Web sites published by publishers when such Web sites are accessed by certain users of the network, thereby delivering the online ads to the users. As shown in FIG. 1, online ad network 100 includes at least one advertiser system/device 102, an ad serving system 104, a creative asset processing system 106, a plurality of publisher Web servers 108₁-108ₙ, and a plurality of user systems/devices 110₁-110ₘ.

Each of publisher Web servers 108₁-108ₙ is configured to host a Web site published by corresponding publisher 1-n so that such Web site is accessible to users of network 100. A user may access such Web sites using a Web browser or other Web client installed on a system/device owned by or otherwise accessible to the user. By way of example, FIG. 1 shows a plurality of user systems/devices 110₁-110ₘ, each of which executes a Web browser that enables a user to visit any of the Web sites hosted by publisher Web servers 108₁-108ₙ. As depicted in FIG. 1, each of client systems/devices 110₁-110ₘ is communicatively connected to publisher 1 Web server(s) 108₁ for the purpose of accessing a Web site published by publisher 1. Persons skilled in the relevant art(s) will recognize that each of user systems/devices 110₁-110ₘ is capable of connecting to any of publisher Web servers 108₁-108ₙ to access the Web sites hosted thereon. Communication between user systems/devices 110₁-110ₘ and publisher Web servers 108₁-108ₙ is carried out over a wide area network, such as the Internet, using well-known network communication protocols.

Ad serving system 104 is configured to deliver online ads to each of publisher Web servers 108₁-108ₙ when the Web sites hosted by such Web servers are accessed by certain users, thereby facilitating the delivery of such online ads to the users. For example, ad serving system 104 may receive the online ads from an advertiser system/device 102. In another example, ad generation module 122 of ad serving system 104 may generate the online ads based on one or more creative assets received from the advertiser system/device 102 via creative asset processing system 106.

Creative asset processing system 106 is configured to process creative assets received from the advertiser system/device 102, so that the creative assets may be included in online ads generated by ad generation module 122 of ad serving system 104. Examples of creative assets include but are not limited to video files, audio files, image files, etc. In one example implementation, creative asset processing system 106 encodes video files into a designated format. For instance, ad serving system 104 may be configured to serve the video files in accordance with only the designated format, though the scope of the present invention is not limited in this respect.

In further accordance with this example implementation, creative asset processing system 106 may be configured to generate a plurality of encoded files corresponding to respective bitrates, based on the uploaded video file. For instance, an advertiser or representative thereof may upload the video file having any of a variety of initial formats, such as Windows Media Video (WMV) format developed by Microsoft Corporation, QuickTime® format developed by Apple Inc., Audio Video Interleave (AVI) format developed by Microsoft Corporation, Motion Picture Experts Group (MPEG) format developed by the Motion Picture Experts Group, etc. using advertiser system/device 102. Creative asset processing system 106 is capable of encoding a video file having any of the initial formats to generate the plurality of encoded files having the designated format.

The bitrates associated with the encoded files correspond to respective bandwidths that may be available for delivering online ads. For instance, creative asset processing system 106 may be configured to generate five encoded files based on the video file. Four of the five encoded files may correspond to bitrates of 100 kilobits per second (kbps), 300 kbps, 700 kbps, and 1000 kbps, respectively. These example bitrates are provided for illustrative purposes and are not intended to be limiting. The fifth encoded file may include a thumbnail view of an image associated with the video file. For example, the thumbnail view may be a frame of the video associated with the video file to serve as a preview of the video.

The advertiser who uploaded the video file may access the encoded files associated with the video file using a Web browser or other Web client installed on advertiser system/device 102, for example. The advertiser may select among the encoded files for inclusion in an online ad. The Web browser may list uniform reference locators (URLs) or other identifiers associated with the respective encoded files, which the advertiser may copy and paste into the online ad, for example.

Creative asset processing system 106 may utilize any of a variety of encoding platforms and/or techniques to encode the video file. For instance, creative asset processing system 106 may use open source software, such as FFmpeg (developed by Fabrice Bellard and maintained by Michael Niedermayer) or MPlayer (developed by Arpad Gereoffy and maintained by Alex Beregszaszi); On2 Flix Engine developed by On2 Technologies Inc.; Carbon Coder/Carbon Server developed by Rhozet, which is a business unit of Harmonic, Inc.; a proprietary encoding technique, etc.

The functionality of creative asset processing system 106 is described herein with continued reference to the example implementation mentioned above, in which video files are encoded into a designated format. It will be recognized, however, that the embodiments described herein are applicable to implementations that are configured to perform any of a variety of processes with respect to any suitable type of creative asset.

As shown in FIG. 1, creative asset processing system 106 includes an attribute determination module 112, a send queue module 114, a poll queue module 116, a receive queue module 118, and a creative asset database 120. Attribute determination module 112 is configured to determine attribute(s) associated with an uploaded creative asset (e.g., a video file in this example). The attribute(s) may be specified in metadata associated with the video file. Accordingly, attribute determination module 112 may review such metadata to determine the attribute(s).

Send queue module 114 performs a send queue job, including storing the uploaded video file, requesting that a process (e.g., an encoding process in this example) be performed with respect to the uploaded video file, calculating a poll time at which the status of the encoding process is to be requested, and creating a poll queue job to be performed by poll queue module 116.

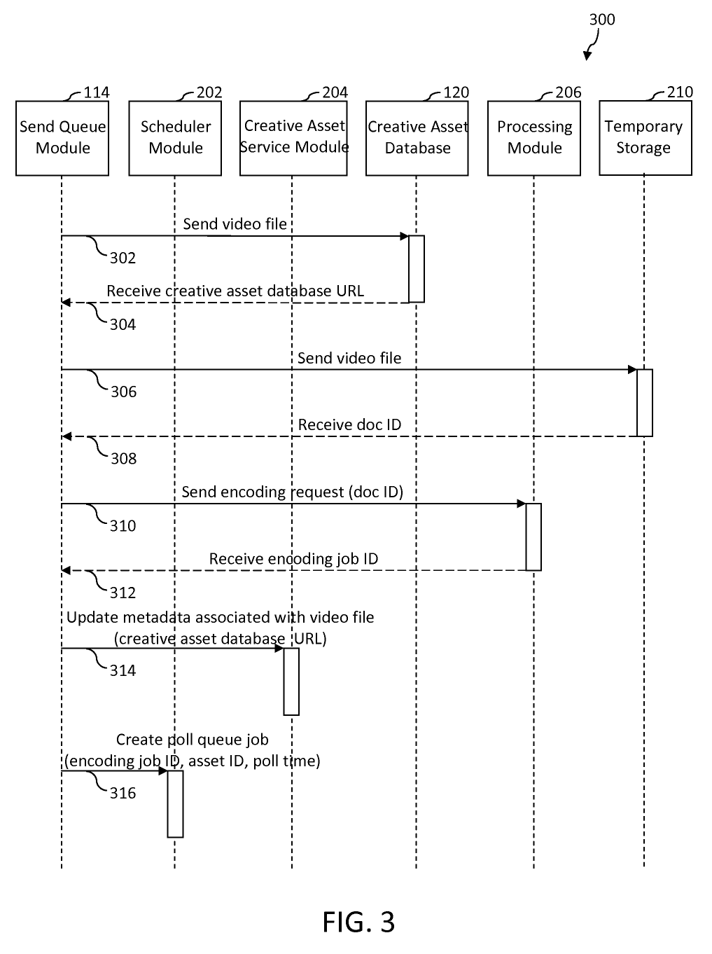

Send queue module 114 calculates the poll time based on at least one attribute of the uploaded video file. Examples of such attributes include but are not limited to a weight (i.e., bit size) of the video file, a duration of a video associated with the video file, dimensions (i.e., number of pixels in the x and y directions) of the video associated with the video file, the designated format into which the video file is being encoded, etc. The send queue job is described in greater detail below in section III of this document with reference to activity diagram 300 of FIG. 3.

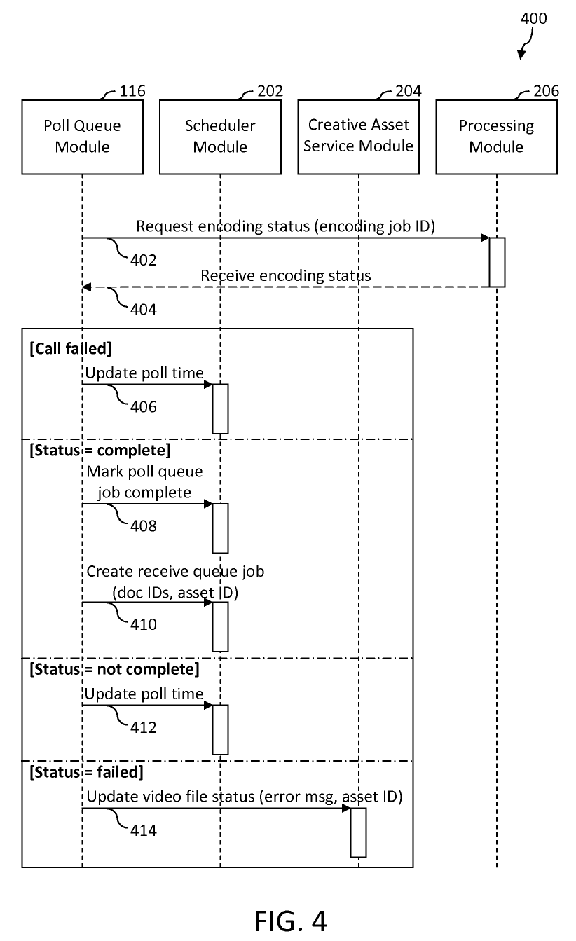

Poll queue module 116 performs a poll queue job, which includes polling the encoding process at the poll time to determine whether the encoding process has been completed. The encoding process may generate a plurality of encoded files based on the uploaded video file, with each encoded file being associated with a respective bitrate. For instance, a first encoded file may be configured to run at a first bit rate. A second encoded file may be configured to run at a second bitrate, and so on. The poll queue job is described in greater detail below in section III of this document with reference to activity diagram 400 of FIG. 4.

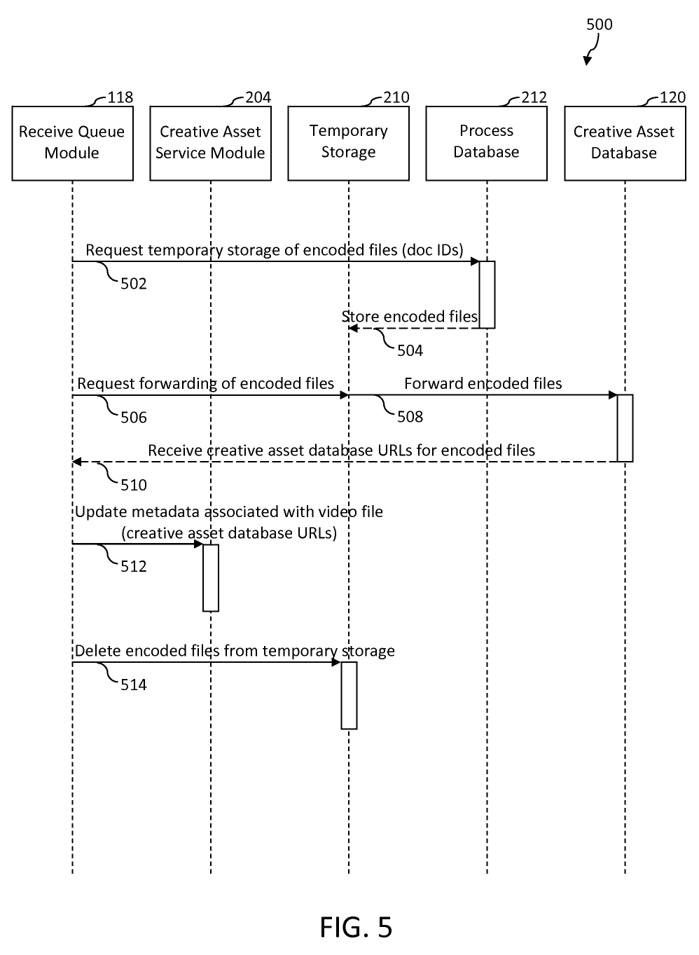

Receive queue module 118 performs a receive queue job when the encoding process has been completed. The receive queue job includes storing the encoded files in creative asset database 120, which is accessible to ad serving system 104, so that ad generation module 122 may incorporate the encoded files into online ads. The receive queue job is described in greater detail below in section III of this document with reference to activity diagram 500 of FIG. 5.

Communication among advertiser system/device 102, ad serving system 104, and creative asset processing system 106 is carried out over a wide area network, such as the Internet, using well-known network communication protocols. Although one advertiser system/device 102 is depicted in FIG. 1, persons skilled in the relevant art(s) will recognize that any number of advertiser system/devices may be communicatively coupled to ad serving system 104 and/or creative asset processing system 106. For instance, the functionality of creative asset processing system 106 may be accessible to one or more advertisers or representatives thereof via respective advertiser system/devices.

Although advertiser system/device 102 and user systems/devices 110₁-110ₘ are depicted as desktop computers in FIG. 1, persons skilled in the relevant art(s) will appreciate that advertiser system/device 102 and user systems/devices 110₁-110ₘ may include any browser-enabled system or device, including but not limited to a laptop computer, a personal digital assistant, a cellular telephone, or the like.

### III. Example Creative Asset Processing System

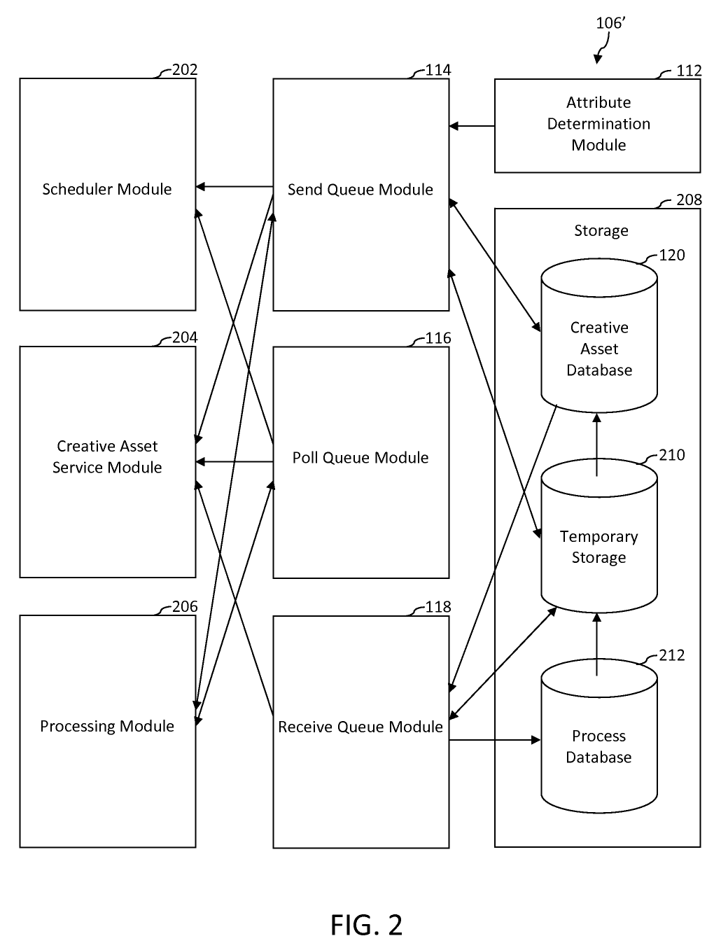

FIG. 2 is a block diagram of an example implementation 106′ of creative asset processing system 106 shown in FIG. 1 in accordance with an embodiment of the present invention. As shown in FIG. 2, creative asset processing system 106′ includes a scheduler module 202, a creative asset service module 204, a processing module 206, and storage 208. Scheduler module 202 is configured to launch and/or terminate send queue jobs performed by send queue module 114, poll queue jobs performed by poll queue module 116, and receive queue jobs performed by receive queue module 118. For instance, scheduler module 202 reviews the send queue, the poll queue, and the receive queue associated with respective modules 114, 116, and 118 to determine jobs therein that have a start time within a designated time frame (e.g., within 60 seconds in the future, within 120 seconds in the future, etc.). Scheduler module 202 launches jobs within the designated time frame, beginning with the job having the nearest start time and/or the highest priority.

Creative asset service module 204 is configured to update attributes associated with creative assets and encoded files generated therefrom. For instance, if a creative asset is stored in creative asset database 120, creative asset service module 204 may update metadata associated with the creative asset to include an indicator (e.g., a uniform resource locator (URL)) specifying a location in creative asset database 120 at which the creative asset is stored.

Processing module 206 is configured to perform a process in accordance with a request received from send queue module 114. Processing module 206 is further configured to respond to inquiries from poll queue module 116 regarding the status of the process. For instance, processing module 206 may perform an encoding process on a video file that is stored in creative asset database 120 in response to a request from send queue module 114. Processing module 206 may further provide the status of the encoding process when polled by poll queue module 116.

Storage 208 includes creative asset database 120, temporary storage 210, and process database 212. Creative asset database 120 is configured to store uploaded creative assets and encoded files generated therefrom. Temporary storage 210 is configured to store encoded files that are generated by processing module 206 until receive queue module 118 successfully stores the encoded files in creative asset database 120. Process database 212 is configured to store the encoded files when generated by processing module 206 at least until the encoded files are stored in temporary storage 210. In an aspect, process database 212 may be located locally with respect to processing module 206, and temporary storage 210 may be located remotely from processing module 206.

Although only a single creative asset database 120, temporary storage 210, and process database 212 are shown in FIG. 2, persons skilled in the relevant art(s) will appreciate that creative assets and encoded files generated therefrom may be stored in multiple creative asset databases, temporary storage systems, and/or encoder databases.

The elements of creative asset processing system 106′ may be distributed among a plurality of servers, though the scope of the embodiments is not limited in this respect. For instance, scheduler module 202, creative asset service module 204, processing module 206, attribute determination module 112, send queue module 114, poll queue module 116, receive queue module 118, creative asset database 120, temporary storage 210, and process database 212 may be included in respective servers of online ad network 100. It will be recognized, however, that a server in online ad network 100 may include two or more elements of creative asset processing system 106′. For example, a first server in online ad network 100 may include processing module 206 and process database 212. In another example, a second server in online ad network 100 may include scheduler module 202 and send queue module 114.

Each of scheduler module 202, creative asset service module 204, processing module 206, attribute determination module 112, send queue module 114, poll queue module 116, and receive queue module 118 may be implemented in hardware, software, firmware, or any combination thereof. For example, any one or more of scheduler module 202, creative asset service module 204, processing module 206, attribute determination module 112, send queue module 114, poll queue module 116, and receive queue module 118 may be implemented as computer code configured to be executed in one or more processors. In another example, any one or more of scheduler module 202, creative asset service module 204, processing module 206, attribute determination module 112, send queue module 114, poll queue module 116, and receive queue module 118 may be implemented as hardware logic/electrical circuitry. In yet another example, any one or more of scheduler module 202, creative asset service module 204, processing module 206, attribute determination module 112, send queue module 114, poll queue module 116, and receive queue module 118 may be implemented as firmware embedded in one or more hardware devices. In still another example, any one or more of scheduler module 202, creative asset service module 204, processing module 206, attribute determination module 112, send queue module 114, poll queue module 116, and receive queue module 118 may be implemented as a combination of computer code, hardware logic/electrical circuitry, and/or firmware.

It should be noted that creative asset processing system 106′ is provided for illustrative purposes and is not intended to be limiting. Persons skilled in the relevant art(s) will recognize that other creative asset processing system implementations fall within the spirit and scope of the present invention.

FIG. 3 depicts an activity diagram 300 of a send queue job in accordance with an embodiment of the present invention. As shown in FIG. 3, the send queue job of activity diagram 300 begins at step 302 in which send queue module 114 sends a video (or other creative asset) to creative asset database 120. At step 304, send queue module 114 receives a creative asset database uniform resource locator (URL) or other indicator indicating the location of the video file in creative asset database 120.

At step 306, send queue module 114 sends the video (or other creative asset) to temporary storage 210. At step 308, send queue module 114 receives a document identifier (doc ID) corresponding to the video file from temporary storage 210.

Send queue module 114 sends an encoding request (or other processing request) to processing module 206 at step 3 10. The encoding request includes the doc ID corresponding to the video file, which processing module 206 may use to locate the video file. At step 312, send queue module 114 receives an encoding job identifier (ID) from processing module 206. For instance, processing module 206 may assign the encoding job ID to the encoding process that is performed with respect to the video file stored in creative asset database 120.

At step 314, send queue module 114 sends a request to creative asset service module 204 to update metadata associated with the video file to includde the creative asset database URL. The request includes the creative asset database URL associated with the video file. Creative asset service module 204 updates the metadata associated with the video file to include the creative asset database URL in response to receiving the request from send queue module 114.

At step 316, send queue module 114 sends a request to scheduler module 202 to create a poll queue job. The request includes the encoding job ID received from processing module 206, an asset ID, and a poll time. The asset ID is a unique identifier assigned to the video file by creative asset service module 204. For instance, creative asset service module 204 may generate the asset ID based on the creative asset type, though the scope of the embodiments are not limited in this respect.

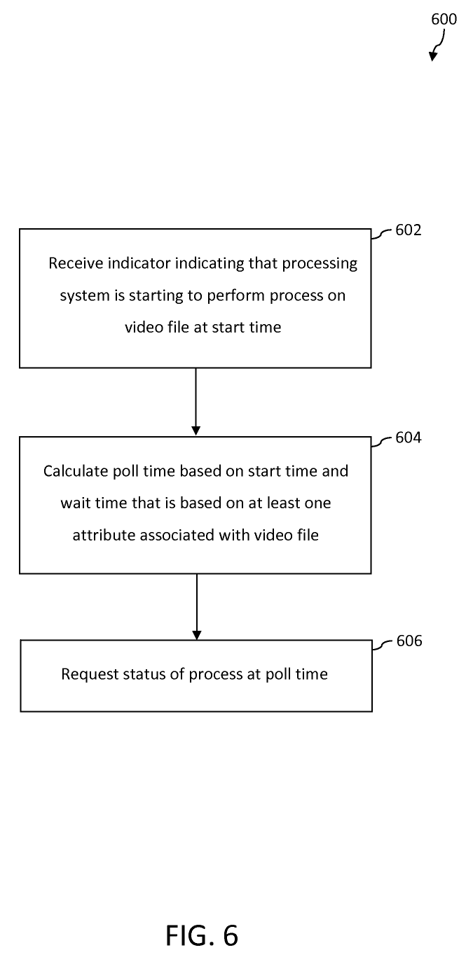

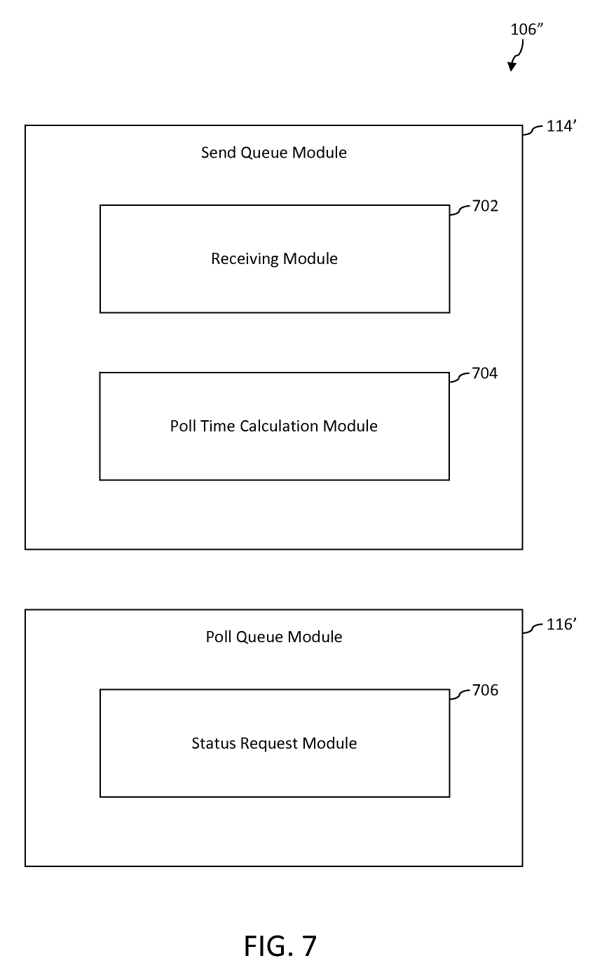

Send queue module 114 calculates the poll time based on at least one attribute of the video file. The at least one attribute may be determined by attribute determination module 112, though the scope of the present invention is not limited in this respect. For example, the poll time may be based on a duration of the video associated with the video file, a weight of the video file, dimensions of the video associated with the video file, the type of encoding used to encode the video file, etc. Some techniques for calculating the poll time are described in further detail below with reference to FIGS. 6 and 7. In further accordance with step 316, scheduler module 202 creates (i.e., launches) the poll queue job using the encoding job ID, the asset ID, and the poll time in response to receiving the request from send queue module 114.

FIG. 4 depicts an activity diagram 400 of a poll queue job in accordance with an embodiment of the present invention. As shown in FIG. 4, the poll queue job of activity diagram 400 begins at step 402 in which poll queue module 116 requests the status of the encoding process (or other process) being performed by processing module 206 at the poll time. The request includes the encoding job ID assigned to the encoding process by processing module 206, so that enable processing module 206 may determine to which encoding process the request pertains. At step 404, poll queue module 116 receives the status of the encoding process from processing module 206.

Poll queue module 116 determines which of a variety of operations to perform based on the status of the encoding process. For example, if processing module 206 does not respond to the request for status provided by poll queue module 116 at step 402 (i.e., the call failed), poll queue module 116 updates the poll time at step 406. The updated poll time may be a fixed time after the initial poll time, though the scope of the embodiments is not limited in this respect.

If the status of the encoding process is “complete,” poll queue module 116 marks the poll queue job as being complete at step 408. Scheduler module 202 may terminate the poll queue job in response to poll queue module 116 marking the poll queue job as complete. At step 410, poll queue module 116 sends a request to schedule module 202 to create a receive queue job. The request includes the asset ID associated with the video file (or other creative asset) and document identifiers (doc IDs) corresponding to respective encoded files associated with video file. The doc IDs are received by poll queue module 116 from processing module 206 at step 404 in response to the encoding process being “complete.” For instance, the doc IDs may not be received at step 404 if the status of the encoding process is anything other than “complete.” Scheduler module 202 creates (i.e., launches) the receive queue job using the asset ID and the doc IDs corresponding to the respective encoded files in response to receiving the request from poll queue module 116.

If the status of the encoding process is “not complete,” indicating that processing module 206 is still (or has not yet begun) performing the encoding process with respect to the video file, poll queue module 116 updates the poll time at step 412. Processing module 206 may be configured to limit the duration of the poll queue job. For example, processing module 206 may be configured to provide a status of “failed” if the number of times that the poll time is updated reaches a threshold. In another example, processing module 206 may be configured to provide the status of “failed” if the poll queue job takes longer than a designated period of time. Alternatively, poll queue module 116 may be configured to limit the duration of the poll queue job. For instance, poll queue module 116 may determine that the status is “failed” based on the number of times processing module 206 provides a status of “not complete” or “call failed”, or based on the elapsed time of the poll queue job.

If the status of the encoding process is “failed,” indicating that poll queue module 116 will no longer poll processing module 206 for the status of the encoding process, poll queue module 116 sends a request to creative asset service module 204 to update the status of the video file at step 414. The request includes an error message and the asset ID of the video file. Creative asset service module 204 updates the status of the video file using the error message and the asset ID in response to receiving the request from poll queue module 116. For instance, creative asset service module 204 may update metadata associated with the video file to include the error message. The updated status of the video file indicates to the advertiser or representative thereof who uploaded the video file that the encoding process was not successfully performed.

FIG. 5 depicts an activity diagram 500 of a receive queue job in accordance with an embodiment of the present invention. As shown in FIG. 5, the receive queue job of activity diagram 500 begins at step 502 in which receive queue module 118 sends a request to process database 212 to store the encoded files in temporary storage 210. Receive queue module 118 includes the document identifiers (doc IDs) that were received by poll queue module 116 from processing module 206 at step 404 in the request to process database 212. For instance, receive queue module 118 may generate the doc IDs based on the asset ID of the video file to which the encoded files correspond. At step 504, process database 212 stores the encoded files in temporary storage 210 in response to receiving the request from receive queue module 118. For instance, process database 212 may match the doc IDs to the respective encoded files based on a knowledge of the algorithm used by processing module 206 to generate the doc IDs upon successful completion of the encoding process.

At step 506, receive queue module 118 sends a request to temporary storage 210 to forward the encoded files to creative asset database 120. At step 508, temporary storage 210 forwards the encoded files to creative asset database 120 in response to receiving the request from receive queue module 118. Receive queue module 118 receives creative asset database URLs or other indicators indicating the respective locations of the encoded files in creative asset database 120 at step 510.

At step 512, receive queue module 118 sends a request to creative asset service module 204 to update the video file stored in creative asset database 120 to include the creative asset database URLs of the encoded files that are also stored in creative asset database 120. The request includes the creative asset database URLs associated with the respective encoded files. Creative asset service module 204 updates the metadata associated with the video file to include the creative asset database URLs in response to receiving the request from receive queue module 118.

At step 514, receive queue module 118 deletes the encoded files from temporary storage 210. For instance, receive queue module 118 may perform step 514 in response to receiving an indicator indicating that the encoded files have been successfully stored in creative asset database 120. In an aspect, receiving the creative asset database URLs at step 510 may serve as an indication to receive queue module 118 that the respective encoded files are successfully stored in creative asset database 120.

Any one or more of steps 502-514 may be performed with respect to any one or more of the encoded files at once. For example, the steps 502-514 of activity diagram 500 may be performed for each encoded file independently, rather than for all encoded files at once. The steps 502-514 may be performed a first time with respect to a first encoded file, a second time with respect to a second encoded file, and so on.

Creative asset database 120 may continue to store the video file even after the encoded files are stored in creative asset database 120 in case a need arises to re-generate the encoded files. For instance, one or more of the encoded files may become corrupted or deleted, in which case send queue module 114 may send another request to processing module 206 to perform the encoding process again, as described above with reference to step 310 of activity diagram 300.

FIG. 6 depicts a flowchart 600 of a method for polling a process based on a calculated poll time in accordance with an embodiment of the present invention. Flowchart 600 may be performed by creative asset processing system 106 of online ad network 100 shown in FIG. 1, for example. For illustrative purposes, flowchart 600 is described with respect to a creative asset processing system 106″ shown in FIG. 7, which is an example implementation of creative asset processing system 106, according to an embodiment of the present invention. As shown in FIG. 7, creative asset processing system 106″ includes a send queue module 114′ and a poll queue module 116′. Send queue module 114′ includes a receiving module 702 and a poll time calculation module 704. Poll queue module 116′ includes a status request module 706. Further structural and operational embodiments will be apparent to persons skilled in the relevant art(s) based on the discussion regarding flowchart 600. Flowchart 600 is described as follows.

As shown in FIG. 6, the method of flowchart 600 begins at step 702 in which receiving module 702 receives an indicator indicating that a processing system (e.g., processing module 206) is starting to perform a process on a video file at a start time. For instance, the indicator may be an encoding job ID assigned to the process by the processing system, as described above with reference to step 312 of activity diagram 300.

At step 604, poll time calculation module 704 calculates a poll time based on the start time and a wait time. The wait time is based on at least one attribute associated with the video file. For instance, an attribute may be a weight (i.e., bit size) of the video file, a duration of a video associated with the video file, dimensions (i.e., number of pixels in the x and y directions) of the video associated with the video file, etc.

In an example implementation, the wait time is calculated to be a first time in a range between twenty seconds and sixty seconds plus a second time that is approximately four times the duration of the video that is associated with the video file. For instance, the first time may be approximately forty seconds, and the second time may be calculated as 4.1 times the duration of the video that is associated with the video file. This example implementation is provided for illustrative purposes and is not intended to be limiting. Persons skilled in the relevant art(s) will recognize that the wait times and poll times described herein may be calculated in accordance with any suitable respective calculation operations, so long as the calculation operations take into account at least one attribute of the video file.

At step 606, status request module 706 requests the status of the process at the poll time. For instance, status request module 706 may send the request to the processing module as described above with reference to step 402 of activity diagram 400.

The embodiments described herein have a variety of benefits as compared to conventional status polling techniques. For example, embodiments are capable of estimating the time necessary to perform a process with respect to a creative asset based on one or more attributes of the creative asset. Embodiments request the status of the process at a time that is based on the estimated time, rather than polling at an arbitrary or preset time that is independent of any attributes of the creative asset. Accordingly, the intelligent polling techniques described herein may be more efficient than conventional status polling techinques. Moreover, the intelligent status polling techniques may consume less bandwidth and/or fewer resources of a system, as compared to conventional polling techniques.

### IV. Example Computer System Implementation

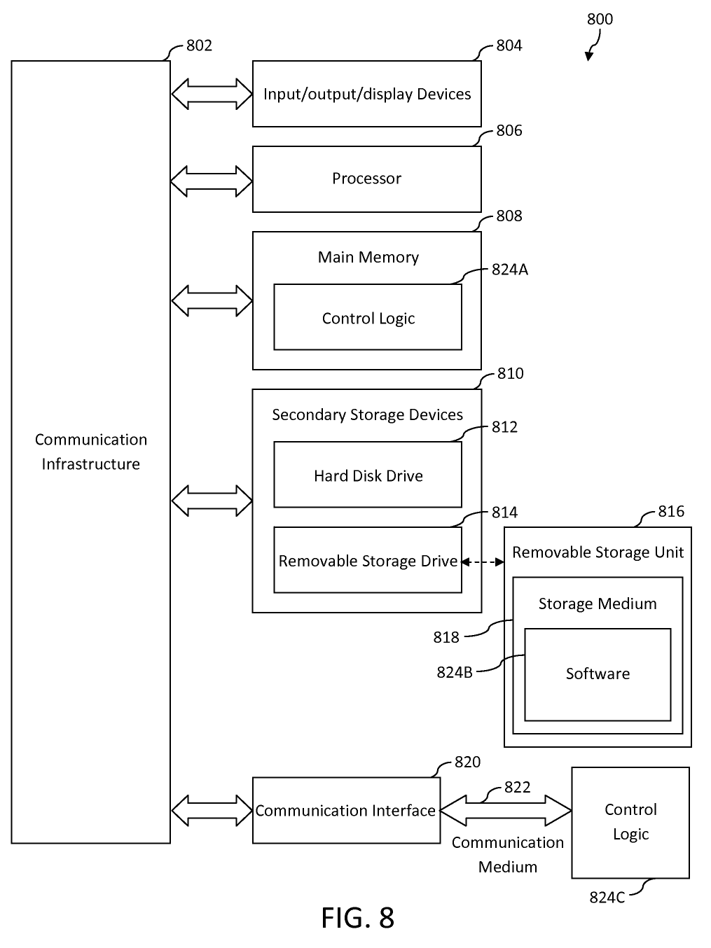

The embodiments described herein, including systems, methods/processes, and/or apparatuses, may be implemented using well known servers/computers, such as computer 800 shown in FIG. 8. For example, elements of example online ad network 100, including creative asset processing system 106 depicted in FIGS. 1, 2, and 7, and each of the steps of activity diagrams 300, 400, and 500 and flowchart 600 depicted in respective FIGS. 3, 4, 5, and 6, can each be implemented using one or more computers 800.

Computer 800 can be any commercially available and well known computer capable of performing the functions described herein, such as computers available from International Business Machines, Apple, Sun, HP, Dell, Cray, etc. Computer 800 may be any type of computer, including a desktop computer, a server, etc.

As shown in FIG. 8, computer 800 includes one or more processors (e.g., central processing units (CPUs)), such as processor 806. Processor 806 may include scheduler module 202 of FIGS. 2, 3, and 4; creative asset service module 204 of FIGS. 2, 3, 4, and 5; processing module 206 of FIGS. 2, 3, and 4; attribute determination module 112 of FIGS. 1 and 2; send queue module 114 of FIGS. 1, 2, 3, and 7; poll queue module 116 of FIGS. 1, 2, 4, and 7; receive queue module 118 of FIGS. 1, 2, and 5; or any portion or combination thereof, for example, though the scope of the embodiments is not limited in this respect. Processor 806 is connected to a communication infrastructure 802, such as a communication bus. In some embodiments, processor 806 can simultaneously operate multiple computing threads.

Computer 800 also includes a primary or main memory 808, such as a random access memory (RAM). Main memory has stored therein control logic 824A (computer software), and data.

Computer 800 also includes one or more secondary storage devices 810. Secondary storage devices 810 include, for example, a hard disk drive 812 and/or a removable storage device or drive 814, as well as other types of storage devices, such as memory cards and memory sticks. For instance, computer 800 may include an industry standard interface, such as a universal serial bus (USB) interface for interfacing with devices such as a memory stick. Removable storage drive 814 represents a floppy disk drive, a magnetic tape drive, a compact disk drive, an optical storage device, tape backup, etc.

Removable storage drive 814 interacts with a removable storage unit 816. Removable storage unit 816 includes a computer useable or readable storage medium 818 having stored therein computer software 824B (control logic) and/or data. Removable storage unit 816 represents a floppy disk, magnetic tape, compact disc (CD), digital versatile disc (DVD), Blue-ray disc, optical storage disk, memory stick, memory card, or any other computer data storage device. Removable storage drive 814 reads from and/or writes to removable storage unit 816 in a well known manner.

It will be apparent to persons skilled in the relevant art(s) that storage 208 of FIG. 2 or a portion thereof (e.g., any one or more of creative asset database 120, temporary storage 210, and/or process database 212) may be included in main memory 808, secondary memory 810, removable storage unit 816, or some combination thereof, though the scope of the embodiments is not limited in this respect.

Computer 800 also includes input/output/display devices 804, such as monitors, keyboards, pointing devices, etc.

Computer 800 further includes a communication or network interface 820. Communication interface 820 enables computer 800 to communicate with remote devices. For example, communication interface 820 allows computer 800 to communicate over communication networks or mediums 822 (representing a form of a computer useable or readable medium), such as local area networks (LANs), wide area networks (WANs), the Internet, etc. Network interface 820 may interface with remote sites or networks via wired or wireless connections. Examples of communication interface 822 include but are not limited to a modem, a network interface card (e.g., an Ethernet card), a communication port, a Personal Computer Memory Card International Association (PCMCIA) card, etc.

Control logic 824C may be transmitted to and from computer 800 via the communication medium 822.

Any apparatus or manufacture comprising a computer useable or readable medium having control logic (software) stored therein is referred to herein as a computer program product or program storage device. This includes, but is not limited to, computer 800, main memory 808, secondary storage devices 810, and removable storage unit 816. Such computer program products, having control logic stored therein that, when executed by one or more data processing devices, cause such data processing devices to operate as described herein, represent embodiments of the invention.

For example, each of the elements of example online ad network 100, including creative asset processing module 106 depicted in FIGS. 1, 2, and 7 and its sub-elements, and each of the steps of activity diagrams 300, 400, and 500 and flowchart 600 depicted in respective FIGS. 3, 4, 5, and 6 can be implemented as control logic that may be stored on a computer useable medium or computer readable medium, which can be executed by one or more processors to operate as described herein.

The invention can be put into practice using software, hardware, and/or operating system implementations other than those described herein. Any software, hardware, and operating system implementations suitable for performing the functions described herein can be used.

### V. Conclusion

While various embodiments of the present invention have been described above, it should be understood that they have been presented by way of example only, and not limitation. It will be apparent to persons skilled in the relevant art(s) that various changes in form and details can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method comprising:
receiving an indicator indicating that a processing system is starting to perform a process on a video file at a start time;
calculating a poll time based on the start time and a wait time that is based on at least one attribute associated with the video file; and
requesting a status of the process at the poll time.

2. The method of claim 1, wherein the wait time is based on metadata associated with the video file.

3. The method of claim 1, wherein the wait time is based on a duration of a video associated with the video file.

4. The method of claim 3, wherein the wait time is further based on a weight of the video file.

5. The method of claim 3, wherein the wait time is substantially equal to a first time that is in a range between twenty seconds and sixty seconds plus a second time that is approximately four times the duration of the video.

6. The method of claim 3, wherein the wait time is represented by the equation Y=40 seconds+4.1*X, wherein Y is the wait time, and wherein X is the duration of the video.

7. The method of claim 1, wherein the wait time is based on a weight of the video file.

8. The method of claim 1, wherein receiving the indicator includes receiving the indicator indicating that the processing system is starting to perform an encoding process on the video file at the start time, the method further comprising:
performing the encoding process to provide a plurality of encoded files associated with a plurality of respective bitrates.

9. A computer program product comprising a computer-readable medium having computer program logic recorded thereon for enabling a processor-based system to poll a process performed with respect to a video file, comprising:
a first program logic module for enabling the processor-based system to calculate a poll time based on a start time and a wait time in response to receiving an indicator indicating that the process is starting at the start time, wherein the wait time is based on at least one attribute associated with the video file; and
a second program logic module for enabling the processor-based system to poll the process at the poll time.

10. The computer program product of claim 9, wherein the wait time is based on metadata associated with the video file.

11. The computer program product of claim 9, wherein the wait time is based on a duration of a video associated with the video file.

12. The computer program product of claim 9, wherein the wait time is based on a weight of the video file.

13. The computer program product of claim 9, wherein the process is an encoding process, the computer program product further comprising:
a third program logic module for enabling the processor-based system to perform the encoding process to provide a plurality of encoded files associated with a plurality of respective bitrates.

14. A system comprising:
a processing module configured to perform a process on a video file;
a poll time calculation module configured to calculate a poll time based on at least one attribute associated with the video file; and
a status request module configured to request a status of the process at the poll time.

15. The system of claim 14, wherein the poll time calculation module is further configured to determine the at least one attribute based on metadata associated with the video file.

16. The system of claim 14, wherein the poll time is based on a duration of a video associated with the video file.

17. The system of claim 16, wherein the poll time is further based on a weight of the video file.

18. The system of claim 16, wherein the poll time is substantially equal to a first time that is indicative of a start time of the process plus a buffer time of less than or equal to sixty seconds plus a second time that is approximately four times the duration of the video.

19. The system of claim 14, wherein the poll time is based on a weight of the video file.

20. The system of claim 14, wherein the process is an encoding process for which the processing module is configured to provide a plurality of encoded files associated with a plurality of respective bitrates.
